(19) United States
(12) Patent Application Publication
(10) Pub. No.: US 2025/0319904 A1
(43) Pub. Date: Oct. 16, 2025

(54) Method for Predicting Trajectories of Road Users

(71) Applicant: Robert Bosch GmbH, Stuttgart (DE)

(72) Inventors: Juergen Luettin, Renningen (DE); Lavdim Halilaj, Leonberg (DE); Zixu Wang, Muenchen (DE)

(21) Appl. No.: 19/170,810

(22) Filed: Apr. 4, 2025

(30) Foreign Application Priority Data
Apr. 10, 2024 (DE) 10 2024 203 277.8

(51) Int. Cl. B60W 60/00

(52) U.S. Cl. CPC B60W 60/0027; B60W 2552/10; B60W 2554/404

(57) ABSTRACT

A method for predicting trajectories of road users includes (i) representing a traffic scene as an agent interaction graph, each having a node for a road user corresponding to a target vehicle and for one or more other road users and having a plurality of edges, wherein each edge between two of the nodes is associated with a respective edge type, which indicates a type of movement of the road users represented by the nodes relative to each other on a respective roadway, (ii) processing the agent interaction graph by a graph transformer to determine embeddings of the target vehicle and the one or more other road users, wherein the graph transformer has an attention mechanism which takes into account the edge types of the edges of the agent interaction graph, and (iii) predicting at least one trajectory of the target vehicle from the embeddings.

This application claims priority under 35 U.S.C. § 119 to application no. DE 10 2024 203 277.8, filed on Apr. 10, 2024 in Germany, the disclosure of which is incorporated herein by reference in its entirety.

The present disclosure relates to methods for predicting trajectories.

### BACKGROUND

In the area of autonomous systems, predicting the behavior of moving objects in the vicinity of a controlled agent (such as a vehicle) is an important task in order to reliably control the agent and to avoid collisions, for example.

For example, an autonomous vehicle must be capable of anticipating the future development of a travel situation, which in particular includes the behavior of other vehicles in the vicinity of the autonomous vehicle, in order to enable performant and safe automated driving. Determining a control of the autonomous vehicle, e.g., represented by a future trajectory to be followed by the autonomous vehicle, therefore must include the behavior of other vehicles. The vehicles to be taken into account for the autonomous vehicle (ego vehicle) are also called target vehicles.

Accordingly, reliable approaches to predict agent behavior, i.e., to determine (expected) trajectories in a multi-agent scenario, are desirable.

The publication H. Cesar et al., “nuScenes: A multimodal dataset for autonomous driving,” 2020, https://arxiv.org/abs/1903.11027, hereinafter referred to as Reference 1, describes the nuScenes dataset.

### SUMMARY

According to various embodiments, a method for predicting trajectories of road users is provided, which features:
representing a traffic scene as an agent interaction graph, each having a node for a road user corresponding to a target vehicle and for one or more other road users and having a plurality of edges, wherein each edge between two of the nodes is associated with a respective edge type, which indicates a type of movement of the road users represented by the nodes relative to each other on a respective roadway
processing the agent interaction graph by a graph transformer to determine embeddings of the target vehicle and the one or more other road users, wherein the graph transformer has an attention mechanism which takes into account the edge types of the edges of the agent interaction graph, and
predicting at least one trajectory of the target vehicle from the embeddings.

The attention algorithm typically has the calculation of an attention between two nodes, with which a message between the two nodes is weighted, with which node attributes of one of the two nodes are weighted.

The method allows for predicting the trajectories of surrounding vehicles for an automated driving system of a vehicle to be controlled (also referred to as an “ego vehicle”). For example, the influence of surrounding (or “nearby”) road users (in particular other vehicles) is explicitly modeled in the agent interaction graph by defining different types of relationships between the target vehicle and the surrounding road users (such as “driving back-to-back,” “on adjacent traffic lanes and same direction of travel,” “on adjacent traffic lanes and opposite direction of travel,” “crossing (possible collision),” “crossing pedestrians (possible collision)”). This allows the interaction and influence of the other (i.e., surrounding) road users to be differentiated and accurately modeled, resulting in a trajectory prediction with high accuracy.

In other words, various types of relationships between the target vehicle, i.e., the vehicle whose trajectory is to be predicted, and the surrounding road users which could affect the trajectory of the target vehicle are used for predicting vehicle trajectories. Surrounding road users (in particular other vehicles) typically have a strong influence on the behavior of a target vehicle. This influence is explicitly modeled according to various embodiments by taking into account the position of the surrounding vehicles in the traffic lane and the map topology relative to the target vehicle in the trajectory prediction. For example, speed, travel directions and distances between vehicles may also be taken into account.

Various exemplary embodiments are specified in the following.

Exemplary embodiment 1 is a method for predicting trajectories of road users as described above.

Exemplary embodiment 2 is a method according to exemplary embodiment 1, wherein the attention mechanism takes into account the edge types of the edges of the agent interaction graph by having for each edge type a respective set of attention mechanism parameters (weights, e.g., a respective weight matrix, e.g., for combining, e.g., weighted multiplication of keys and values or also for, e.g., weighted multiplication of the node attributes of a node in order to calculate a message of the node), wherein the sets of attention mechanism parameters can be trained individually (i.e., may thus also be different, i.e., different attention weights (e.g., weighted matrices for the attention algorithm) may be used for different edge types, if this results in this way during training).

A heterogeneous graph (agent interaction graph) with different edge types (and also node types such as vehicle and pedestrian) may be converted and/or processed in this manner, wherein a trajectory prediction model is first trained and then used to predict trajectories, taking into account different edge types. As one edge type can, for example, reflect whether another road user is important to a target vehicle (e.g., in terms of the traffic lanes in which both are traveling) (i.e., influence on the target vehicle), this can thereby be effectively taken into account in the trajectory prediction.

Exemplary embodiment 3 is a method according to exemplary embodiment 1 or 2, wherein each of the edges has one or more edge attribute values indicating the quantitative characteristics of the movement of the road users represented by the nodes relative to each other, and which the attention mechanism takes into account.

In addition to the edge types, quantitative variables of the (relative) movement can thus also be taken into account, e.g., the Euclidean distance between the road users, the distance between the road users along the traffic lane, the speed difference between the road users, the directional difference between the road users (e.g., angular difference with respect to a reference direction) and time to collision. For example, the edge attributes are taken into account by adding them in a layer of the graph transformer when updating the embedding of a node (i.e., node attributes) to a previous node embedding (from the previous graph transformer layer).

Exemplary embodiment 4 is a method according to any of exemplary embodiments 1 to 3, wherein the type of movement is one of side-by-side, back-to-back and intersecting.

Which of these movement types the vehicles have relative to each other typically has a great influence on how the vehicles continue to move (provided they are sufficiently close to each other). The “intersecting” edge type can, for example, exist in two versions—“intersecting—for another vehicle” and “pedestrian-crossing.”

Exemplary embodiment 5 is a method according to any of exemplary embodiments 1 to 4, wherein the trajectories are further determined from at least one of an encoding of the movement of the target vehicle, an encoding for each of the other road users, of the movement of the other road user and encodings of traffic lane nodes of one or more graphs representing one or more traffic lanes of the traffic scene.

Thus, the embeddings provided by the graph transformer are combined (or merged) with further encodings regarding the movements of the road users or the traffic lane(s) for the trajectory prediction. This increases the quality of the trajectory prediction.

Exemplary embodiment 6 is a method according to any of exemplary embodiments 1 to 5, further comprising controlling an (ego) vehicle, taking into account the at least one predicted trajectory.

Exemplary embodiment 7 is a vehicle control device which is set up to perform a method according to any of exemplary embodiments 1 to 6.

Exemplary embodiment 8 is a computer program with instructions that, when executed by a processor, cause the processor to carry out a method according to any of exemplary embodiments 1 to 6.

Exemplary embodiment 9 is a computer-readable medium that stores instructions that, when executed by a processor, cause the processor to perform a method according to any of exemplary embodiments 1 to 6.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the disclosure. In the following description, various aspects are described with reference to the following drawings.

FIG. 1 shows a vehicle.

FIG. 2 illustrates a flow for trajectory prediction according to one embodiment.

FIG. 3 illustrates two types of edges of the traffic lane graph.

FIG. 4 shows a GRU (Gated Recurrent Unit) according to one embodiment.

FIG. 5 illustrates the encoding of the agent trajectories by neural networks formed from GRUs.

FIG. 6 illustrates the encoding of the traffic lane graph by a neural network formed from GRUs.

FIG. 7 shows a real-world traffic scene and a corresponding agent interaction graph.

FIG. 8 illustrates a dynamic heterogenous graph encoder (DHGE) according to one embodiment.

FIG. 9 illustrates a graph transformer.

FIG. 10 illustrates the encoding of an agent interaction graph.

FIG. 11 shows a (machine) information fusion model according to one embodiment.

FIG. 12 illustrates CA (cross attention) processing by a sub-model of the information fusion model of FIG. 11.

FIG. 13 shows a flow chart illustrating a method for predicting trajectories of road users.

### DETAILED DESCRIPTION

The following detailed description relates to the accompanying drawings, which, for clarification, show specific details and aspects of this disclosure and its implementation. Other aspects can be used, and structural, logical and electrical changes can be performed without departing from the scope of protection of the disclosure. The various aspects of this disclosure are not necessarily mutually exclusive since some aspects of this disclosure can be combined with one or a plurality of other aspects of this disclosure to form new aspects.

Different examples will be described in more detail in the following.

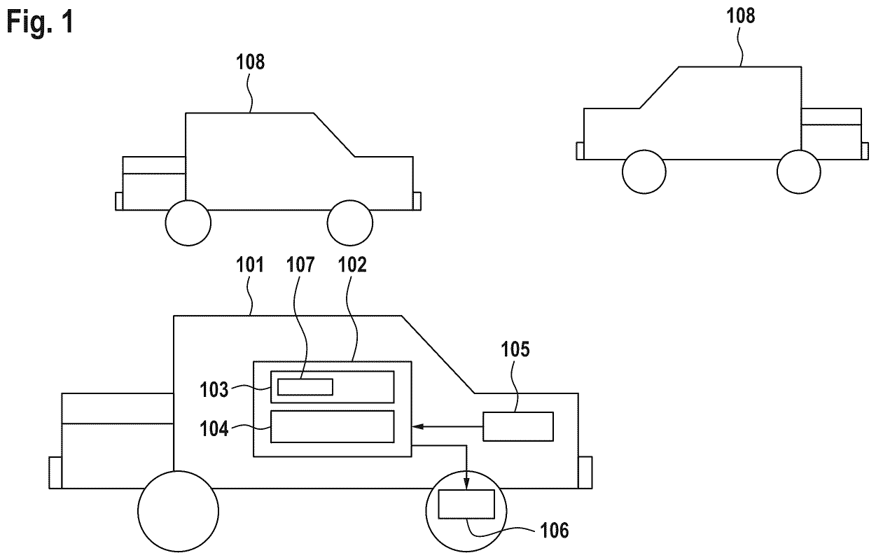

FIG. 1 shows a vehicle 101.

In the example of FIG. 1, a vehicle 101, for example a car or truck, is equipped with a vehicle control device 102.

The vehicle control device 102 has data processing components, e.g., a processor (e.g., a CPU (central processing unit)) 103 and a memory 104 for storing control software according to which the vehicle control device 102 operates, and data processed by the processor 103.

For example, the saved control software (computer program) has instructions that, when executed by the processor, cause the processor 103 to implement a machine learning (ML) model 107.

The data stored in the memory 104 may, for example, include image data captured by one or a plurality of cameras 105. For example, the one or the plurality of cameras 105 may take one or a plurality of grayscale photographs or color photographs of the surroundings of the vehicle 101. Using the image data (or also data from other sources of information, such as other types of sensors or also vehicle-to-vehicle communications), the vehicle control device 102 can detect objects in the surroundings of the vehicle 101, in particular other vehicles 108, and can determine their previous trajectories and thus capture a traffic scene.

The vehicle control device 102 can examine the sensor data and control the vehicle 101 according to the results, i.e., determine control actions for the vehicle and signal them to respective actuators of the vehicle. For example, the vehicle control device 102 can control an actuator 106 (e.g., a brake) in order to control the speed of the vehicle, e.g., to brake the vehicle.

The control device 102 must include the behavior of the further vehicles 108, i.e., their future trajectories, in determining a future trajectory 101 for the vehicle 101. The control device 106 must thus predict the (future) trajectories of the other vehicles 108 (generally “agents”), i.e., in other words traffic movements. The vehicle 101 for which the prediction is made (i.e., that is controlled based on the prediction, for example) is also hereinafter referred to as the ego vehicle. A vehicle 108 whose trajectory is predicted is hereinafter referred to as a target agent or target vehicle.

While there are many models for predicting vehicle trajectories, most models are unable to adequately model interactions between road users. While some models utilize agent graphs, they often lack semantic meaning and related features in their relationships. However, understanding the semantic relationships and associated features between the agents may be critical to an accurate trajectory prediction. To close this gap, according to various embodiments, a trajectory prediction approach is used that integrates a dynamic heterogeneous agent interaction graph and a fusion module to combine various information and provide a full understanding of a scene graph.

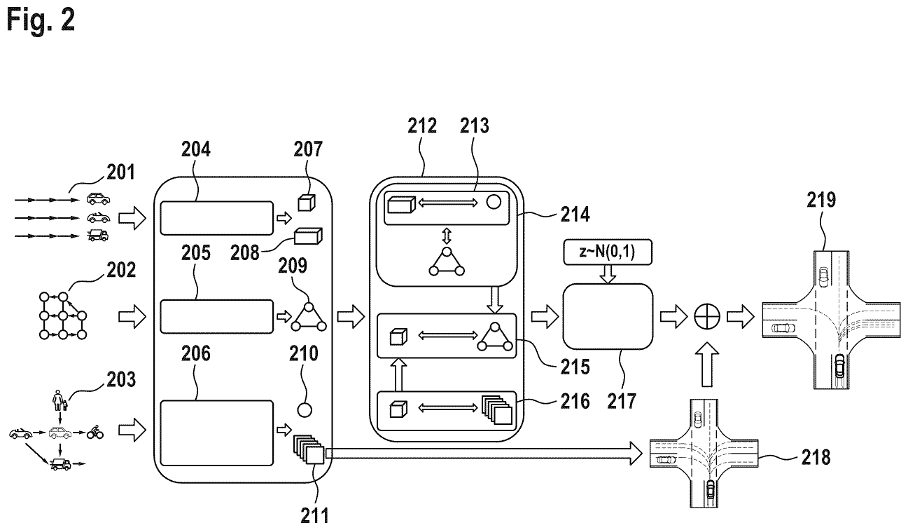

FIG. 2 illustrates a flow for trajectory prediction according to one embodiment.

As shown in FIG. 2, the trajectory prediction is divided into three distinct phases according to one embodiment. First, the agent information 201 is encoded into a target agent (movement) encoding 207 and an all-surrounding-vehicle (movement) encoding 208 by way of an agent encoder 204. In addition, a traffic lane graph 202 is encoded into a traffic lane encoding 209 by a traffic lane encoder 205. In addition, an agent interaction graph 203 is encoded by a dynamic heterogeneous graph encoder (DHGE) 206 (agent interaction information encoder) to an environmental agent node embedding 210 (such as with edge to the target agent node) and a dynamic target agent node embedding 211.

Subsequently, an information fusion model (or information fusion module) 212 integrates the various encodings (embeddings) 207-211 with the aid of four sub-models 213, 214, 215, 216 and thus forms a holistic representation, i.e., a merged encoding. Finally, a decoder 217 uses the merged encoding to predict a multimodal trajectory. Moreover, the dynamic target agent node embedding 211 is utilized from the agent interaction graph 203 directly by an interaction-based predictor 218 for predicting the trajectory (as an auxiliary task). From the output of the decoder 217 and the output of the interaction-based predictor 218, the trajectories 219 of the agents (all surrounding vehicles and the target agent) are predicted.

According to one embodiment, a graphic representation for a map of the surrounding area in the form of the traffic lane graph 202 is used. The motivation for using a traffic lane graphic representation is complex. In the complex environment of city traffic, it is essential for an autonomous vehicle to not only know the physical layout of the roadway, but also the permissible routes available to it. This includes permitted maneuvers such as turning at intersections, changing lanes on highways and turning into ramps. By representing these paths in the form of a graph, the autonomous vehicle can efficiently plan its route and ensure that it is compliant with traffic rules and travel safely.

The center lines of the traffic lanes are at the center of this graphic representation. By focusing on the center lines that mark the middle path of each traffic lane on the road, the overall geometry and structure of the road can be sufficiently captured. To determine the traffic lane graph 202, after vectorization of map information (from a map of the surrounding area, e.g., that is present to the vehicle 101), the center lines of the traffic lanes are extracted. They are then represented as a directed graph, which is designated G={V, E}. Instead of taking into account all traffic lanes of the map, a restriction is made to the traffic lanes and their connecting sections that are located in an 80 meter radius of the target agent. These traffic lanes are then divided into segments that each extend over 20 meters before being discretized into a sequence of poses at a distance of 1 meter. Thus, each node corresponds to a roadway segment that is 20 meters long. For other road elements, stop lines and pedestrian crossings within the same 80 meter radius are taken into account. When polygons and traffic lane lines overlap, the corresponding flags (that indicate a stop line or a crosswalk) are combined by one-hot encoding (i.e., an encoding that has one bit position for each such type and contains a one in one bit position if the type applies, and zero otherwise). This method can be used to determine whether traffic lanes match stop lines of crosswalks. The features of the traffic lane nodes contain the traffic control data. Each node v in this representation denotes a sequence of pose vectors

$${f}_{1 : N}^{v} = [ {f}_{1}^{v} , {f}_{2}^{v} , … , {f}_{N}^{v} ] \qquad ( 1 )$$

wherein each pose is characterized by:

$${f}_{n}^{v} = [ {x}_{n}^{v} , {y}_{n}^{v} , {θ}_{n}^{v} , {flag}_{n}^{v} , {flag}_{n}^{v} ] \qquad ( 2 )$$

wherein the two flags indicate whether the pose is on a stop line and/or on a crosswalk.

Here

$${x}_{n}^{v} , {y}_{n}^{v}$$

are the local coordinates for the nth pose and

$${θ}_{n}^{v}$$

the yaw angle of the respective pose.

As far as the relationships between the nodes are concerned, there are two types of edges in the traffic lane graph 202.

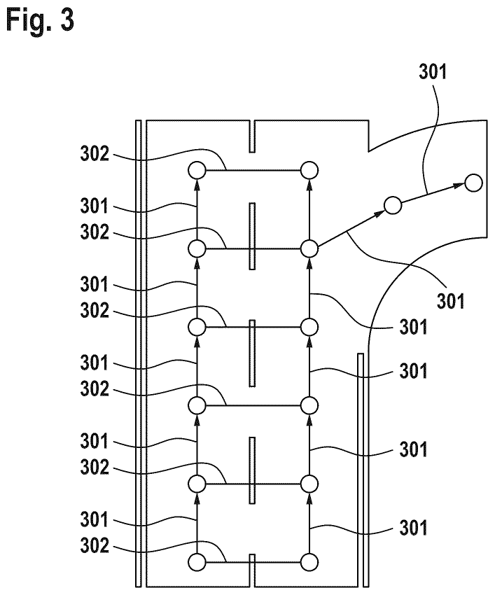

FIG. 3 illustrates two types of edges of the traffic lane graph 202.

The two types are successor edges 301 and proximal edges 302. A successor edge 301 ensures continuity to the next node along a traffic lane so that a legitimate trajectory is maintained. When a traffic lane node (e.g., node A) is located at an intersection, it may be associated with multiple successors. In contrast, the proximal edges 302 are intended to represent legal traffic lane changes between adjacent traffic lanes that have the same direction of travel. To this end, it connects adjacent traffic lane nodes that are within a distance of, for example, 4 meters. This threshold value was selected based on typical traffic lane widths and the safety buffer required for traffic lane changes. The yaw angle difference, which is kept below 4, ensures that only traffic lanes that are approximately parallel to each other and not at a sharp angle to each other are connected.

This is critical to prevent illegal overtaking or traffic lane changes into traffic lanes in the opposite direction.

Both the target agent and the agents surrounding it are represented (in the agent information 201) as sequences of temporal vectors:

$${f}_{n}^{T} = [ {f}_{n}^{t = - 4} , {f}_{n}^{t = - 3} , … , {f}_{n}^{t = 0} ] \qquad ( 3 )$$

wherein n indicates the individual agent. The surrounding agents include all agents except the target agent in the traffic scene under consideration, regardless of their distance or relevance to the target agent. They can be categorized as either a human or a vehicle.

Each fₙ^{t} is represented as

$${f}_{n}^{t} = [ {x}^{t} , {y}^{t} , {vel}^{t} , {acc}^{t} , y {r}^{t} ] \qquad ( 4 )$$

The index t extends from the earliest observable frame to the current frame of the scene under consideration, wherein

$${f}_{n}^{t}$$

covers a few seconds, for example. The value yr denotes the yaw rate.

As described above, the agent encoder 204 encodes the trajectories of the agents (from the agent information 201) including those of the target agent and the surrounding agents, and the traffic lane encoder 205 encodes the traffic lane graph 202 (and thus the features of the traffic lane nodes).

The main goal of these encodings is to convert the raw traffic lane and agent data into a format that can be easily processed by a subsequent encoder. For encoding, in one embodiment, three MLPs (multi layer perceptrons) are used.

Considering the sequential nature of the data, such as the features of the traffic lane nodes and the trajectories of the agents, GRUs (Gated Recurrent Units) are used for encoding according to one embodiment. A GRU network (i.e., a neural network of GRUs) is a variant of a recurrent neural network. Its strength lies in effectively capturing long-term dependencies contained in sequential data. By introducing two gates, namely the update and reset gate, a GRU network is able to retain relevant data over time.

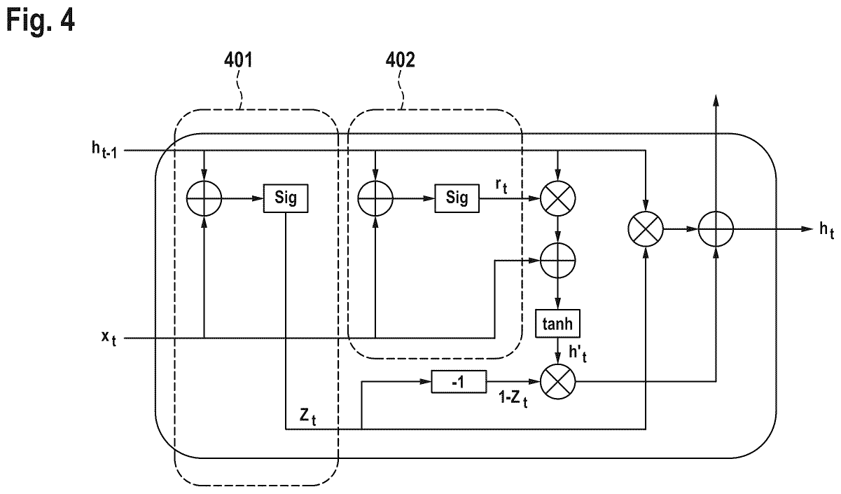

FIG. 4 shows a GRU 400 according to one embodiment.

The GRU includes an update gate 401 and a reset gate 402. These gates are critical for determining the flow of information through the neural network (made up of a plurality of such GRUs). The update gate evaluates how much of the previous state (ht−1) is to be retained, while the reset gate decides how the current input should be integrated with historical information. Both gates operate via vectors with values between 0 and 1 that modulate the interaction between the input data and the previous hidden state. This operative paradigm may be represented mathematically as follows:

$${r}_{t} = σ ( {W}_{r} {x}_{t} + {U}_{r} {h}_{t - 1} + {b}_{r} ) \qquad ( 5 )$$

$${z}_{t} = σ ( {W}_{z} {x}_{t} + {U}_{z} {h}_{t - 1} + {b}_{z} ) \qquad ( 6 )$$

$${\tilde{h}}_{t} = tanh ( W {x}_{t} + U ( {r}_{t} ⊙ {h}_{t - 1} ) + b ) \qquad ( 7 )$$

$${h}_{t} = ( 1 - {z}_{t} ) ⊙ {h}_{t - 1} + {z}_{t} ⊙ {\tilde{h}}_{t} , \qquad ( 8 )$$

wherein xt is the input at time t, ht−1 is the previous (hidden) state and rt and z characterize the reset gate 402 and/or the update gate 401, respectively. The icon ⊙ symbolizes the elementary multiplication. The weight matrices W, U and the bias vectors b are the parameters learned during training.

GRUs are particularly suitable for this task as they can process sequential data by capturing time dependencies, making it a suitable choice for encoding time series such as trajectories.

In this way, the traffic lane node features

$${f}_{1 : N}^{v}$$

and the trajectories of the agents

$${f}_{n}^{T}$$

are encoded separately. In the following, the index ta is used for the target agent and the index sa is used for the surrounding agents. The traffic lane node features follow the traffic lane direction sequence, while the trajectories of the agents have a temporal sequence.

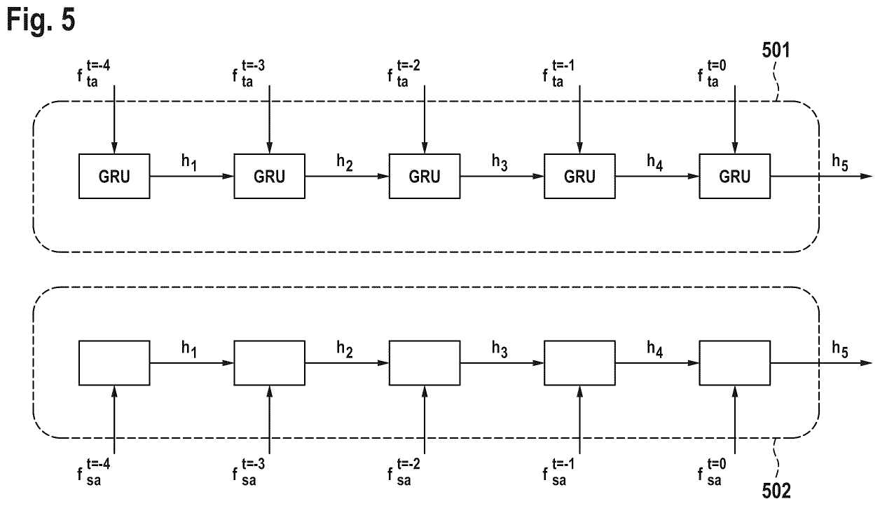

FIG. 5 illustrates the encoding of the agent trajectories by neural networks formed from GRUs (GRU encoders) 501, 502.

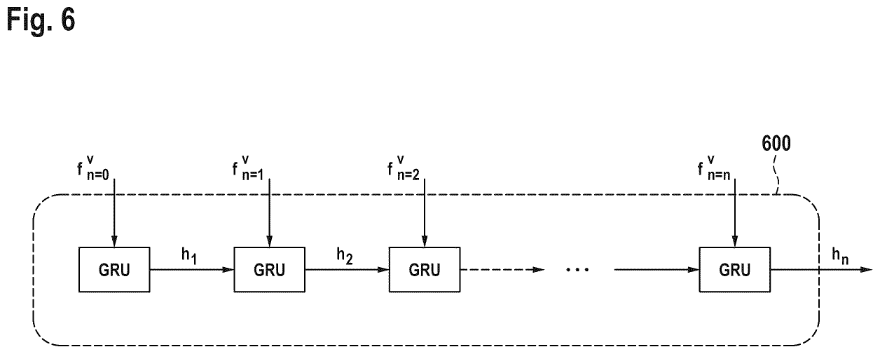

FIG. 6 illustrates the encoding of the traffic lane graph by a neural network formed from GRUs (GRU encoder) 600.

As shown in FIGS. 5 and 6, the states are updated by the GRU cells and transmitted to the subsequent GRU cell during sequence processing. When these states pass through the GRU encoder, the final hidden state contains the spatial information contained in the sequence. This output from each GRU encoder 501, 502, 600 serves as an embedding for the movement of the target agent (hta), surrounding agent (hsa) and/or traffic lane node features (hl), respectively. All of these embeddings are represented in a 32-dimensional space.

By the encoding of the agent information 201 described above, i.e., the target agent encoding 207 and an all-surrounding-vehicle encoding 208, in particular all surrounding agents (surrounding the target agent, i.e., the target vehicle) within the scene under consideration are represented. However, not all of these agents affect the target vehicle. When driving, people rely on a complex interplay of factors to decide which vehicles (or general agents) are most important in the surroundings. Factors such as the relative speed of the surrounding agents, their distance from the target vehicle, their trajectories and traffic rules determine these decisions. For example, a vehicle located directly in front of the target vehicle and traveling at distinctly lower speed may have more influence than a fast vehicle in a parallel lane that is not intersecting. Likewise, a vehicle that is waiting to turn from an intersecting traffic lane may have priority in the decision-making of the target vehicle due to traffic rules and the risk associated with turning.

According to one embodiment, an agent interaction graph 203 is used as an input derived from, for example, the nuScenes Trajectory Prediction Graph dataset (see reference 1) and identifies the key agents in the surroundings that are related to the movement of the target vehicle and decision-making. The agent interaction graph may also be derived from any other driving scene provided the map information and agent information is present. It also shows the semantic relationships and attributes between them.

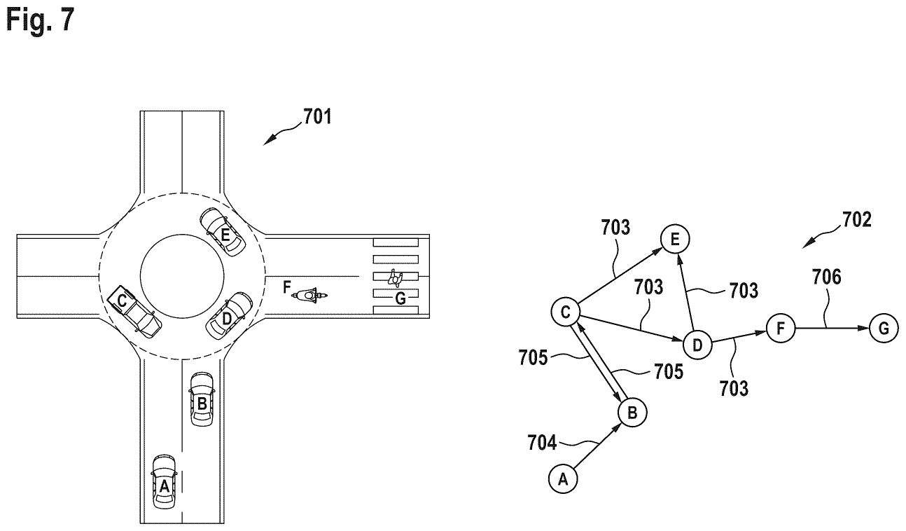

FIG. 7 shows a real-world traffic scene 701 and a corresponding agent interaction graph 702. The agent interaction graph shows the semantic relationships between the agents characterized by edge types: Lateral (side-by-side), longitudinal (back-to-back), crossing and pedestrian (or “pedestrian-crossing”). The relationships between the agents are characterized by these four different edge types. The first three types-longitudinal 703, lateral 704 and crossing 705—are equipped with three edge attributes, which are designated with

$${f}_{edge}^{( s , t )} = [ distance , path distance , edge probability ] .$$

The distance attribute quantifies the Euclidean distance between two agents. Path distance measures the distance traveled along a particular path, and edge probability indicates the probability of a particular relationship. The edge type pedestrian 706 does not have the path distance attribute.

The following describes how the dynamic heterogeneous graph encoder (DHGE) 206 processes the agent interaction graph 702.

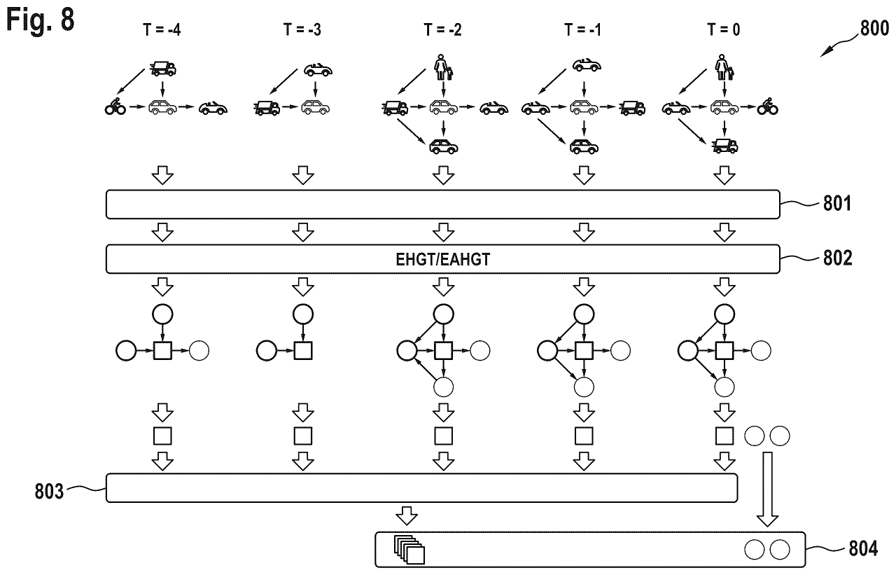

FIG. 8 illustrates a dynamic heterogenous graph encoder (DHGE) 800 according to one embodiment. It has three parts: A specific-type encoder 801, an EHGT (edge-enhanced heterogeneous graph transformer 802) and a temporal encoder (on a GRU basis) 803.

Different MLPs are used as the specific-type encoder 801 to encode node features of different agent types, as vehicles and pedestrians may have different behavioral patterns. The EHGT 802 is then used to encode the agent interaction graph 702. Finally, the temporal encoder 803 is used to capture temporal information from the graph encoding across individual timestamps.

A heterogeneous graph transformer is capable of capturing and representing different types of nodes and relationships within a single graph. Its design allows for the flexible integration of various entities and their relationships, making it particularly suitable for the present application.

At its core, an HGT (heterogenous graph transformer) operates with interaction matrices that model specific elements within a relationship and share parameters for better generalization. In addition, HGT uses meta-relationships to parametrize weight matrices.

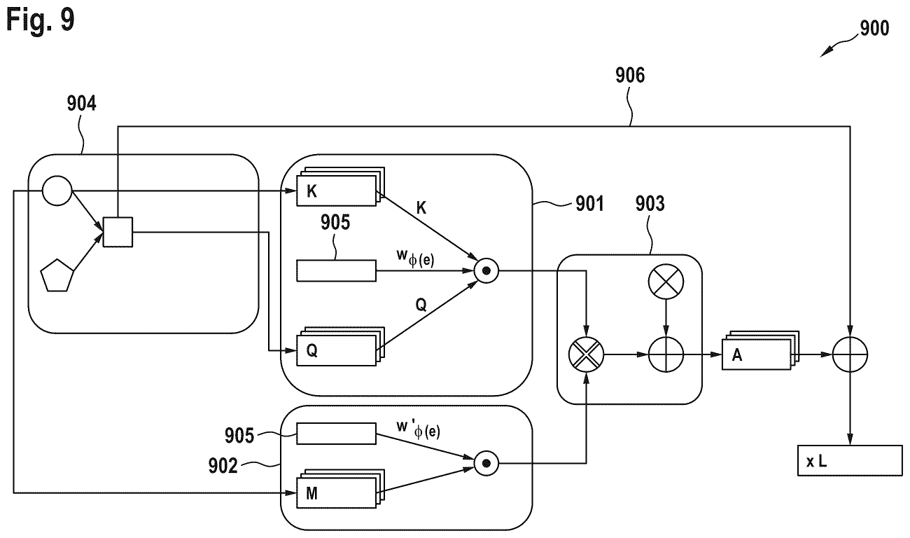

FIG. 9 illustrates a graph transformer 900.

The graph transformer 900 obtains a heterogeneous subgraph 904 as an input and has three components: Heterogeneous mutual attention 901, heterogeneous message forwarding 902 and target-specific aggregation 903.

In the HGT, the attention mechanism deviates from the standard GAT (graph attention network). Rather than relying on a single weight matrix that requires a homogeneous distribution of features between source and target nodes, HGT introduces the mutual attention based on relation triplets structured as <source nodes, edge, target nodes>. The target node t is projected onto a query vector while the source node s is mapped to a key vector:

$${K}_{( s )}^{i} = {K\_Linear}_{τ ( s )}^{i} ( {H}^{l - 1} [ s ] ) \qquad ( 9 )$$

$${Q}_{( s )}^{i} = {Q\_Linear}_{τ ( s )}^{i} ( {H}^{l - 1} [ t ] ) , \qquad ( 10 )$$

wherein H^{(l-1)} the input is from the previous layer and i relates to the specific attention head. Each node type has a unique linear projection.

The attention head is calculated as described by the following equation:

$${ATT\_head}^{i} ( s , e , t ) = ( {K}^{i} ( s ) {W}_{ϕ ( e )}^{ATT} {{Q}^{i} ( t )}^{T} ) \cdot \frac{{μ}_{< τ ( s ) , ϕ ( e ) , τ ( t ) >}}{\sqrt{d}} \qquad ( 11 )$$

wherein

$${W}_{ϕ ( e )}^{ATT}$$

is a matrix specific to the edge type 905, which is intended to capture the semantic relationships Φ(e) between nodes. This matrix allows the model to recognize and capture different semantic relationships itself between nodes of the same type. The attention mechanism is determined by a point product operation ⊙. Moreover, d is an adaptive parameter indicative of the overall importance of each relation triplet, while d represents the dimensionality of the vector.

Then, h attention heads are linked and the Softmax function is applied to determine the final attention weights for each relation triplet as defined by the following equation:

$${Att}_{HGT} ( s , e , t ) = {Softmax}_{s ∈ N ( t )} ( {‖}_{i ∈ [ 1 , h ]} {ATT\_head}^{i} ( s , e , t ) ) \qquad ( 12 )$$

The transfer of information from the source node to the target node is facilitated by heterogeneous message forwarding 902. This process runs in parallel to calculating mutual attention. To obtain the i-th message head MSG_headⁱ(s, e, t), the representation of the source node from the previous layer H^{l-1}[s] is projected by a special-type encoder 905 M-linear. It is then multiplied by an edge type matrix

$${W}_{ϕ ( e )}^{MSG}$$

to integrate edge dependence:

$${MSG\_head}^{i} ( s , e , t ) = {M\_Linear}_{τ ( s )}^{i} ( {H}^{l - 1} [ s ] ) {W}_{ϕ ( e )}^{MSG} \qquad ( 13 )$$

Then, for each node pair, h message nodes are concatenated to receive the message

$${Msg}_{HGT} ( s . e , t ) = {‖}_{i ∈ [ 1 , h ]} {MSG\_head}^{i} ( s , e , t ) \qquad ( 14 )$$

In the subsequent aggregation phase, the messages of all source nodes s are aggregated to the target node t. The attention vector defined in equation (12) serves as a weight for averaging the respective messages from the source nodes, as shown in equation (14). The result is the updated \tilde{H}^{(l)}[t]:

$${H}^{( l )} [ t ] = {⊕}_{∀ s ∈ N ( t )} ( {Att}_{HGT} ( s , e , t ) \cdot {Msg}_{HGT} ( s , e , t ) ) \qquad ( 15 )$$

Thereafter, \tilde{H}^{(l)}[t] contains extensive information about the neighbors of the target node t and the relationships associated therewith. The target node t is then reassigned to its type-specific distribution and supplemented with a residual connection from the previous layer (supplied via a residual connection 906):

$${H}^{( l )} [ t ] = {A\_Linear}_{τ ( t )} ( σ ( {\tilde{H}}^{( l )} [ t ] ) ) + {H}^{( l - 1 )} [ t ] \qquad ( 16 )$$

Although the heterogeneous graph transformer (HGT), like many other graph operators in its category, is capable of encoding a heterogeneous graph, it has a decisive limitation: it is unable to include edge attributes. This means that although it can capture and represent different types of nodes and relationships, it does not use the additional information that can be provided by the attributes associated with the edges. In light of this limitation, according to various embodiments, an edge-enhanced heterogeneous graph transformer (EHGT for “edge-enhanced” HGT) 802 is used for the dynamic heterogeneous graph encoder 206, which can incorporate edge attributes into the mutual attention 901 and message forwarding 902 and thus provide a more comprehensive graph representation.

One strategy for incorporating edge features is edge concatenate HGT (ECHGT), where the edge attribute of an edge is added directly to the source node of the edge. Essentially, this method takes into account the edge attribute as an extension of the source node features within a triplet. This inclusion of the edge attribute is first shown in the calculation of mutual attention, as shown in the following equations.

$${K}_{( s )}^{′ i} = {K\_Linear}_{τ ( s )}^{i} ( {H}^{l - 1} [ s ] + {e\_a}_{< s , e , t >}^{i} ) \qquad ( 17 )$$

$${ATT\_head}^{i} ( s , e , t ) = ( {K}_{e}^{′ i} ( s ) {W}_{ϕ ( e )}^{ATT} {{Q}^{i} ( t )}^{T} ) \cdot \frac{{μ}_{< τ ( s ) , ϕ ( e ) , τ ( t ) >}}{\sqrt{d}} \qquad ( 18 )$$

The edge attribute is referred to here as e_a and/or below also as E_A (for edge attribute).

It is also included in the message forwarding phase, as shown in the equation below.

$${MSG\_head}^{i} ( s , e , t ) = {M\_Linear}_{τ ( s )}^{i} ( {H}^{l - 1} [ s ] + {e\_a}_{< s , e , t >}^{i} ) {W}_{ϕ ( e )}^{MSG} \qquad ( 19 )$$

However, this approach has difficulty with scenarios with triplets having multiple relations.

According to one embodiment, an alternative EHGT strategy is therefore used (also referred to as EAHGT (edge attribute heterogeneous graph transformer)), in which an edge attribute matrix

$${W}_{ϕ ( e )}^{E \_ A}$$

is used for both attention calculation (as shown in equation (20) below) and message forwarding (as shown in equation (21) below). This matrix serves as a representation of the edge attribute information.

$${ATT\_head}^{i} ( s , e , t ) = ( {K}^{i} ( s ) {W}_{ϕ ( e )}^{ATT} {W}_{ϕ ( e )}^{E \_ A} {{Q}^{i} ( t )}^{T} ) \cdot \frac{{μ}_{< τ ( s ) , ϕ ( e ) , τ ( t ) >}}{\sqrt{d}} \qquad ( 20 )$$

$${MSG\_head}^{i} ( s , e , t ) = {M\_Linear}_{τ ( s )}^{i} ( {H}^{l - 1} [ s ] ) {W}_{ϕ ( e )}^{E \_ A} {W}_{ϕ ( e )}^{MSG} \qquad ( 21 )$$

With the aid of the EHGT, it is possible to process heterogeneous graphs with edge attributes.

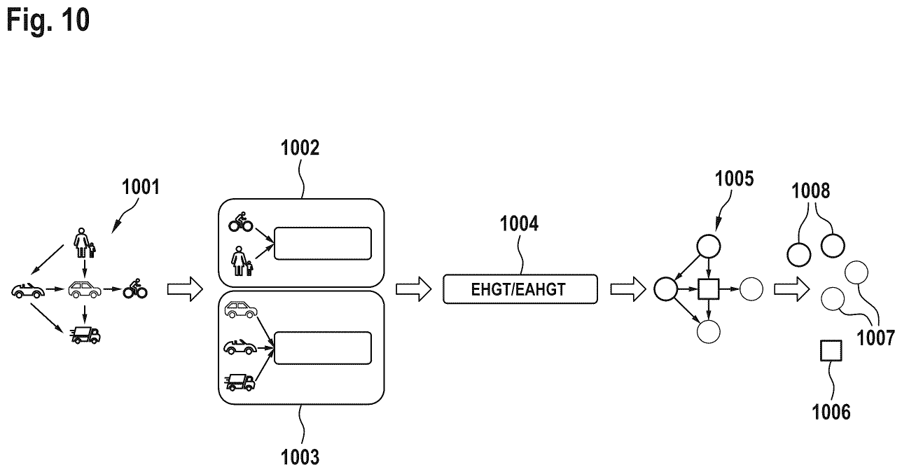

According to various embodiments, the EHGT is used as a GNN (graph neural network) operator to process the interaction of agents in a heterogeneous graph 203. In practical scenarios, it is typically only the immediate neighbor of a target vehicle that significantly affects its behavior. Thus, according to one embodiment, aggregation is limited to one hop, as shown in FIG. 10.

FIG. 10 illustrates the encoding of an agent interaction graph 1001 by two specific-type encoders, a first encoder 1002 for pedestrians and cyclists, and a second encoder 1003 for vehicles, followed by an EHGT 1004. The result is a graph embedding with a target node embedding 1005, and embeddings of surrounding nodes with a directed edge (arrow) to the target node 1006 and surrounding nodes with a directed edge (arrow) from the target node 1007.

It should be noted that neighbors with arrows originating from the target (surrounding nodes with directed edge from the target node 1006) also have influence on this. Therefore, embeddings of these nodes are incorporated into the environmental agent node embedding 210.

It should be further noted that the agent embeddings as described with reference to FIG. 10 are different from the agent embeddings described with reference to FIGS. 4, 5 and 6: While the latter represent all the agents present in a particular scene, the agent embeddings in the agent interaction information encoder 206 are selected to identify agents that are most likely to affect the behavior of the target agent.

After agent information encoding, i.e., heterogeneous graph encoding, we will receive node embeddings containing both spatial and semantic data for each specific timestamp. However, the temporal link or continuity between these timestamp-specific embeddings is still lacking. To integrate this temporal dimension that captures the development of traffic scenes over time, a GRU network (i.e., a GRU-based temporal encoder) 803 is used. This GRU network 803 has the task of encoding the target node embeddings from all observed traffic scenes in a temporal order, resulting in a dynamic target node graph embedding gt (corresponding to the dynamic target agent node embedding 211), as shown in FIG. 8.

At the same time, the embedding of the surrounding nodes gs from the last observed traffic scene is retained at t=0, particularly the nodes from which arrows originate from the target agent. This step ensures that no potential agents influencing the prediction are lost sight of.

The output of the heterogenous graph encoder (DHGE) 206, 800 are thus embeddings 804 that include the environmental agent node embedding 210 (and/or environmental agent node embeddings when considered individually) and dynamic target agent node embedding 211.

As already mentioned above in connection with FIG. 2, the various encodings (and/or “embeddings”) 207-211 are now merged by the information fusion model 212 with the aid of four sub-models 213, 214, 215, 216 in order to comprehensively represent the dynamics and interactions in traffic scenes:
Movement encoding of the target agent (ht): This encoding 207 captures the primary movements and patterns associated with the target agent and allows us to understand its inherent motion dynamics.
Encoding of surrounding agents (hs): This encoding 208 provides information about all non-target agents within a traffic scene.
Encoding of traffic lane nodes (hl): This encoding 209 provides information about the structured traffic lanes in the scene.
Dynamic target node graph embedding (gt): Instead of relying only on movement patterns, this encoding 210 represents the interactions and relationships of the target agent in a dynamic graph. It provides a deeper, relational understanding of the position of the target within the wider scene.
Interactive embedding of surrounding agents (gs): This embedding 211 is similar to embedding the target node in the graphs, but for the agents in the surroundings for the current timestamp. It captures how these agents interact with each other and with the target, thereby creating a complete picture of the dynamics between the agents.

These encodings 207-211 provide a multi-faceted representation of the scene and allow for more extensive analysis and more precise predictions.

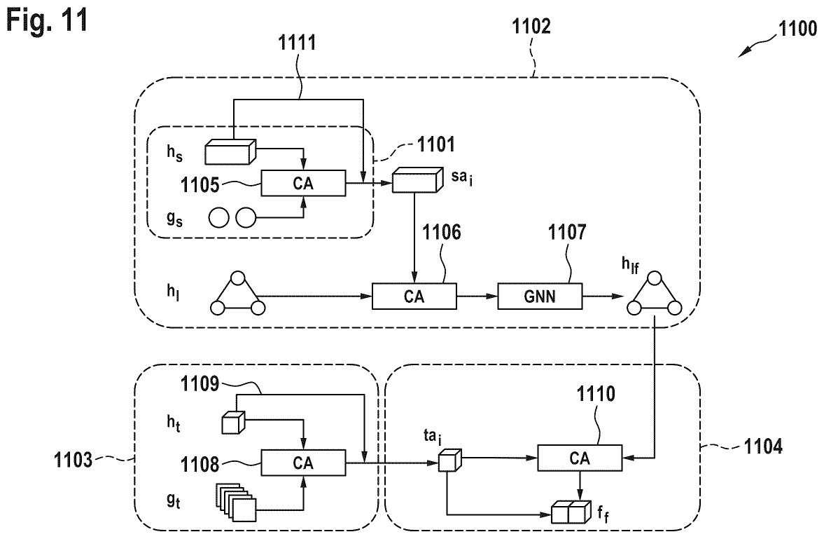

FIG. 11 shows a (machine) information fusion model 1100 according to one embodiment. It is an example of the information fusion model 212 and serves to merge the encodings 207-211.

The output of the information fusion model 212 is designated as ff (for “fusioniert” [merged]).

As already described in the context of FIG. 2, the information fusion model 1100 has four sub-models (or sub-modules) 1101-1104, each of which is specifically configured to process different facets of the information.

These sub-models 1101-1104 are described below.

First sub-model 1101 (surrounding agents and their interactions): The encoding hs contains information about all the agents in a traffic scene except for the target agent. In order to extract meaningful representations that highlight the most influential surrounding agents and understand the importance of their interactions, a cross-attention (CA) mechanism 1105 is used by the first sub-model 1001 as follows:

$$sai = CA ( hs , gs ) + hs \qquad ( 22 )$$

The CA mechanism acts between hs (the GRU-embedding representations of the surrounding agents) and gs (the embeddings that capture the interactive relationships between these agents). The goal is to weigh up and understand which relationships of the surrounding agents are most important in the given context.

An important addition to the CA mechanism is the integration of a skip connection 1111 (realized by adding hs). This addition facilitates the transfer of the original information across the CA layers and ensures that the basic information is not lost during the attention process. Using the skip connection within the model provides two main benefits:
Handling graphs with few edges: In some traffic scenarios, the lack of relationships between agents may pose a difficulty. In such cases, a direct path in the form of a skip connection helps to ensure that the model can still make meaningful predictions without relying too much on non-existent ones.
Model stability: skip connections for this stabilize deep models (i.e., models with many layers). They allow gradients to flow directly backwards through the respective neural network, which can prevent the problem of the vanishing gradients and support the convergence of the model.

Second sub-model 1102 (surrounding agents with interaction and traffic lane information): It implements a (second) cross-attention mechanism 1106 between the surrounding agents with the interaction encoding sai and the traffic lane node representations hl and ensures that the embedding of the traffic lane nodes is refined based on the presence and behavior of the agents in their vicinity. The approach of only considering agents within a given radius around each traffic lane node ensures that the model remains focused on the most relevant interactions and reduces the influence of distant, likely irrelevant agents.

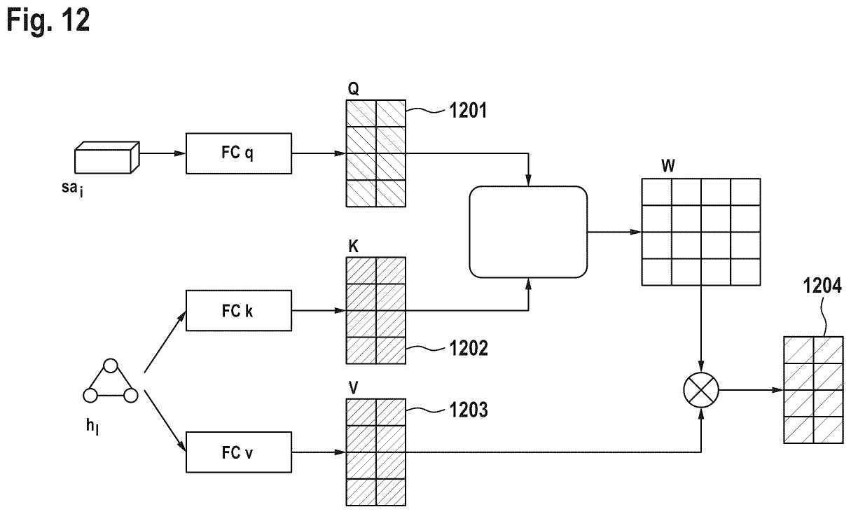

FIG. 12 illustrates CA processing by the second sub-model 1102.

The cross-attention mechanism 1106 retrieves keys (K) 1202 and values (V) 1203 from the surrounding agents with the interaction encoding sai. Queries (Q) 1201 are derived from traffic lane encoding hl. The output 1204 of this attention process is a representation that merges information about the surrounding area of the traffic lane node with its own features of the traffic lane node. Linking this output to hl provides a more comprehensive representation of each traffic lane node, which now includes the context of nearby agents.

The second sub-model 1102 further includes a GAT (graph attention network) encoder (i.e., a GNN (graph neural network) 1107 for traffic lane nodes: According to the cross-attention mechanism 1106, it is ensured that the traffic lane nodes also capture contextual information from their adjacent traffic lane nodes. Using the GAT encoder 1107 ensures that the embedding for a traffic lane node is updated based on its interactions with other associated traffic lane nodes. This step allows the model to capture more details about how traffic lane configurations and neighborhoods can affect the behavior of the agents.

The combination of the cross-attention mechanism 1106 and the GAT encoder 1107 results in a final encoding hlf of traffic lane information that is both contextually informed (relative to the interactive behavior of the agents) and structurally informed (relative to traffic lane configurations). One such dual contextual approach as described by the equation

$${h}_{lf} = GNN ( CA ( {h}_{l} , {sa}_{i} ) ) \qquad ( 23 )$$

can provide more accurate insights into how agents might behave in a particular traffic scene.

Third sub-model 1103 (target agent and its dynamic interaction):

Similar to the first sub-model 1101, the third sub-model 1102 refines the encoding of the target agent ht by merging it with the dynamic target node graph embedding according to

$${ta}_{i} = CA ( {h}_{t} , {g}_{t} ) + {h}_{t} \qquad ( 24 )$$

This ensures that the target agent is aware of the broader context in which it is acting, particularly considering its interactions with nearby agents.

The third sub-model 1103 thus includes
a (third) cross-attention mechanism 1108 for target encoding: This is an attention mechanism where keys and values of gt are derived that contain the dynamic interaction of the target agent with the surrounding agents. The queries come from ht, which represents the embedding of the target agent. This attention mechanism selectively provides the representation of the target agent with relevant interactive context, thus creating hybrid embedding that balances the individual behavior with interaction patterns.
A (second) skip connection 1109: It ensures that the original encoding ht is not completely overshadowed by the embedding informed from interactions.

The output of the third sub-model 1103 is an encoding tai (target agent with interaction) that contains both information about its inherent properties and information about its interactions with other agents.

Fourth sub-model 1104 (target agent with interaction encoding and end encoding of the traffic lane): The fourth sub-model 1104 includes a (fourth) CA mechanism 1110 that helps to balance the relevance of various features of the traffic lane end encoding hlf for the target agent with interaction encoding tai:

$${f}_{f} = Conc ( {ta}_{i} , CA ( {ta}_{i} , {h}_{lf} ) ) \qquad ( 25 )$$

Here, “Conc” stands for concatenating. Intuitively, the fourth CA mechanism 1110 allows the model to focus on the most relevant lane-related information while considering the interaction of a target agent. To this end, the updated and aggregated traffic lane end encoding hlf is projected linearly as the key and values, and the target agent-with-interaction encoding tai is projected linearly as the query of attention. Following the fourth CA mechanism 1110, tai is linked to the CA output. This linking ensures that not only the weighted information is captured from the traffic lanes, but also that the raw interaction details of the target agents are retained. Finally, the merged encoding ff is obtained, which serves as the final encoding provided by the information fusion module.

The fourth sub-model 1104 thus includes:
A linear projection: The encoding of the traffic lane nodes hlf is first subjected to linear transformation to derive key and values, and the target agents with the interaction encoding tai are projected as a query.
A CA mechanism 1110 for merging: The attention mechanism 1110 is then applied. This ensures that the merged encoding captures the most important details from both the traffic lane perspective and the target agent perspective.

Linking for final merger: The output of the attention mechanism 1110, which is a weighted value of the traffic lane node information relative to the target agent, is linked to tai. This provides the refined target agent information with the most relevant traffic lane context. The linked representation serves as the final encoding ff generated by the information fusion module 212. This representation provides a holistic and comprehensive understanding of the target agent's situation in the traffic scene and captures its behavior, interactions and its relationship to the traffic lanes.

The fourth sub-model 1104 represents the final process of information fusion. It provides a complete encoding that includes both the specific details from the point of view of the target agent as well as its interactions with other people and the routes around it.

The decoder 217 uses a latent variable z to allow for the output of different movement profiles. By linking a Gaussian-distributed latent variable z with the merged encoding ff, the decoder 217 is capable of generating different movement profiles to account for inherent uncertainty. Then, an MLP is used to output k modes of the future trajectory

$${\hat{Y}}_{1 : {t}_{f}}^{k} :$$

$${\hat{Y}}_{1 : {t}_{f}}^{k} = MLP ( conc ( {f}_{f} , {z}_{k} ) ) \qquad ( 26 )$$

K-means clustering is then used and the cluster centers are output as final output in the form of K predictions

$$[ {\hat{Y}}_{1 : {t}_{f}}^{1} , {\hat{Y}}_{1 : {t}_{f}}^{2} , … , {\hat{Y}}_{1 : {t}_{f}}^{k} ] .$$

In addition, the embedding gt of the dynamic target node graph directly becomes a trajectory

$${\tilde{Y}}_{1 : {t}_{f}}^{k}$$

and in turn (in the same way as above) a final output

$$[ {\tilde{Y}}_{1 : {t}_{f}}^{1} , {\tilde{Y}}_{1 : {t}_{f}}^{2} , … , {\tilde{Y}}_{1 : {t}_{f}}^{k} ]$$

is obtained. This ensures that the model can utilize the rich relational information from the heterogeneous graph and does not overlook the critical social interactions when making predictions.

The decoder 217 is trained with an average winner-takes-all average offset error. In this way, two losses are determined: A merged regression loss [symbol] _{fr} (where only the best mode from the output of the information fusion model is considered (winner-takes-all)) and a graph regression loss [symbol] _{gr} (the best mode from the embedding gt of the target dynamic node graph):

$${ℒ}_{fr} = {min}_{k} \frac{1}{{t}_{f}} {\sum }_{t = 1}^{{t}_{f}} {‖ {\hat{Y}}_{t}^{k} - {Y}_{t}^{gt} ‖}_{2} \qquad ( 27 )$$

$${ℒ}_{gr} = {min}_{k} \frac{1}{{t}_{f}} {\sum }_{t = 1}^{{t}_{f}} {‖ {\tilde{Y}}_{t}^{k} - {Y}_{t}^{gt} ‖}_{2} \qquad ( 28 )$$

The model is then trained with an overall loss combining these two losses

$$ℒ = {λ}_{1} {ℒ}_{fr} + {λ}_{2} {ℒ}_{gr} \qquad ( 29 )$$

With two scalar weightings λ1 und λ2, this combined loss ensures that the model does not rely too much on one source of information. The combined loss brings together the strengths of both individual losses to make the model learn from the rich spatial, semantic and temporal characteristics embedded in the individual losses and ensure a comprehensive learning process.

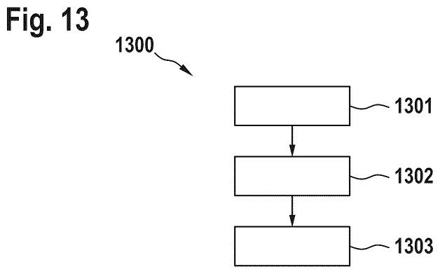

In summary, according to various embodiments, a method as shown in FIG. 13 is provided.

FIG. 13 shows a flowchart 1300 illustrating a method for predicting trajectories of road users.

In 1301, a traffic scene is represented as an agent interaction graph, each having a node for a road user corresponding to a target vehicle and for one or more other road users and having a plurality of edges, wherein each edge between two of the nodes (i.e., each edge that the agent interaction graph includes between two nodes representing road users) is associated with a respective edge type, which indicates a type of movement of the road users represented by the nodes relative to each other on a respective roadway.

In 1302, the agent interaction graph is processed by a graph transformer to determine embeddings of the target vehicle and the one or more other road users, wherein the graph transformer has an attention mechanism that takes into account the edge types of the edges of the agent interaction graph.

In 1303, at least one trajectory of the target vehicle (and, if necessary, also trajectories of the one or more other road users) is predicted from the embeddings.

The method according to FIG. 13 may be performed by one or a plurality of computers comprising one or a plurality of data processing units. The term “data processing unit” can be understood to mean any type of entity that enables the processing of data or signals. The data or signals can, for example, be processed according to at least one (i.e., one or more than one) specific function performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here can also be understood as a data processing unit or logic circuit array. One or a plurality of the method steps described in detail here can be carried out (e.g., implemented) by a data processing unit by way of one or a plurality of specific functions performed by the data processing unit.

According to various embodiments, the method is thus, in particular, computer-implemented.

The traffic situation may be captured by way of sensor data. Various embodiments can receive and use sensor data for this from various sensors, such as video, radar, LiDAR, ultrasound, motion, thermal imaging, etc.

The predicted trajectories may be used to control an ego vehicle (i.e., taking into account, for example, planning a trajectory of the ego vehicle such that, if the predicted trajectories are assumed to be correct, no collision should occur). As described above, the graph transformer may be part of a larger machine learning model, e.g., trained end-to-end, i.e., using example scenarios with future trajectories as ground truth for monitored learning, for example.

What is claimed is:

1. A method for predicting trajectories of road users, comprising:
representing a traffic scene as an agent interaction graph, each having a node for a road user corresponding to a target vehicle and for one or more other road users and having a plurality of edges, wherein each edge between two of the nodes is associated with a respective edge type, which indicates a type of movement of the road users represented by the nodes relative to each other on a respective roadway;
processing the agent interaction graph by a graph transformer to determine embeddings of the target vehicle and the one or more other road users, wherein the graph transformer has an attention mechanism which takes into account the edge types of the edges of the agent interaction graph; and
predicting at least one trajectory of the target vehicle from the embeddings.

2. The method according to claim 1, wherein the attention mechanism takes into account the edge types of the edges of the agent interaction graph by having a respective set of attention mechanism parameters for each edge type, wherein the sets of attention mechanism parameters are individually trainable.

3. The method according to claim 1, wherein each of the edges has one or more edge attribute values indicating the quantitative characteristics of the movement of the road users represented by the nodes relative to each other, and which the attention mechanism takes into account.

4. The method according to claim 1, wherein the type of movement is one of side-by-side, back-to-back and intersecting.

5. The method according to claim 1, wherein the trajectories are further determined from at least one of an encoding of the movement of the target vehicle, an encoding for each of the other road users, of the movement of the other road user and encodings of traffic lane nodes of one or more graphs representing one or more traffic lanes of the traffic scene.

6. The method according to claim 1, further comprising controlling a vehicle, taking into account the at least one predicted trajectory.

7. A vehicle control device configured to carry out a method according to claim 1.

8. A computer program with instructions that, when executed by a processor, cause the processor to carry out a method according to claim 1.

9. A computer-readable medium that stores instructions that, when executed by a processor, cause the processor to carry out a method according to claim 1.
